(19) United States
(12) Patent Application Publication
(10) Pub. No.: US 2023/0214312 A1
(43) Pub. Date: Jul. 6, 2023

(54) MAPPING API DEPENDENCIES FOR A JOURNEY TEST

(71) Applicant: American Express Travel Related Services Company, Iinc., New York, NY (US)

(72) Inventors: Jonathan R. TOAL, Toronto (CA); Joshua J. MOTTER, Phoenix, AZ (US); Praveen SHARMA, Phoenix, AZ (US); Ripan KAPOOR, Delhi (IN); Marcos Diclei Silva BARROS, Sunrise, FL (US); Jaspal Singh VIRK, Phoenix, AZ (US); Narsi Reddy KANCHARLA, Sunrise, FL (US); Parikshith Reddy CHAMAKURA, Phoenix, AZ (US); Kusumakara Rao TANGELLA, Phoenix, AZ (US); Sarath Kumar Reddy KUPPAGIRI, Phoenix, AZ (US)

(73) Assignee: American Express Travel Related Services Company, Inc., New York, NY (US)

(21) Appl. No.: 17/674,605

(22) Filed: Feb. 17, 2022

Related U.S. Application Data
(60) Provisional application No. 63/295,125, filed on Dec. 30, 2021.

(51) Int. Cl. G06F 11/36; G06F 9/54

(52) U.S. Cl. CPC G06F 11/3664; G06F 9/543; G06F 11/3688

(57) ABSTRACT

Disclosed herein are system, method, and computer program product embodiments for mapping API dependencies for a journey test. An embodiment operates by receiving, at a graphical user interface (GUI), a test script representing the user journey within an application, wherein the test script specifies a sequence of application programming interfaces (APIs) that have been called as a user journeys through the application. The embodiment generates an API dependency map within the GUI comprising a sequential map of visual objects, illustrating (1) each of the APIs specified in the test script and (2) any dependent API called by each of the APIs. The embodiment executes the test script representing the user journey. The embodiment generates a status corresponding to each of the APIs called when executing the test script. The embodiment causes display of the generated status of an API or dependent API within the GUI selected by the user.

### FIELD

This field is generally related to validation of a sequence of application programming interfaces across a defined user interaction journey.

### RELATED ART

Software applications are commonly implemented to assist users with accessing online content. As the complexity of user desires grows, multiple applications may be involved in achieving a particular user's goal. For example, a user may access multiple applications or pass data between multiple applications in order to access online content, which may define a user journey. In the process, the applications interface with application programming interfaces (APIs) to achieve a particular user's goals. APIs have become increasingly valuable for enterprises to target specific interactions within a user journey.

With the increase in connected experiences and the growing number of user touchpoints, user journeys have become increasingly complex. To meet this demand, enterprises may create and/or manage thousands of APIs to deliver user experiences. Accordingly, existing API management systems monitor individuals APIs to determine whether the APIs are available. However, the unavailability of an individual API may further impact other APIs or create additional downstream unavailability when multiple APIs are used in a sequence.

Therefore, while individual APIs can be monitored for unavailability, testing engineers are unable to identify which user journey is impacted due to an individual API's unavailability or the unavailability of multiple dependent APIs downstream. As a result, existing API management systems are unable to validate user journeys by mapping the availability of a sequence of APIs.

### BRIEF SUMMARY

Provided herein are system, apparatus, device, method and/or computer program product embodiments, and/or combinations and sub-combinations thereof, for API dependency mapping.

A computer-implemented method is provided for analyzing a test of a user journey within an application. In the method, a test script representing the user journey is received receiving at a graphical user interface (GUI). The test script specifies a sequence of application programming interfaces (APIs) that have been called as a user journeys through the application. An API dependency map is generated within the GUI. The API dependency map includes a sequential map of visual objects. The sequential map illustrates (1) each of the APIs specified in the test script and (2) any dependent API called by each of the APIs. The test script representing the user journey is generated. A status corresponding to each of the APIs and dependent APIs called when executing the test script is generated for presentation within the GUI to a user. A selection of the respective visual objects corresponding to one of the APIs or dependent APIs called when executing the test script is received from the user. The status of APIs presented correspond to respective visual objects representing an API or dependent API selected by the user. Finally, the generated status of APIs are displayed within the GUI.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The accompanying drawings are incorporated herein and form a part of the specification.

FIG. 1 is a block diagram illustrating a system architecture for API dependency mapping, according to some embodiments.

FIG. 2A is an example of an API management graphical user interface (GUI) displaying an API configuration tool for configuring APIs, according to some embodiments.

FIG. 2B is an example of a dashboard of an API management system displaying analytics of various platforms, applications, and services, according to some embodiments.

FIG. 2C is an example of an API management GUI displaying the APIs managed by an API management system, according to some embodiments.

FIGS. 3A and 3B are examples of an API management GUI displaying an API dependency tool used to create a user journey test script, according to some embodiments.

FIG. 3C is an example of an API management GUI displaying an API dependency tool used to add an API dependency within a user journey test script, according to some embodiments.

FIG. 3D is an example of an API management GUI displaying a parent API mapped within a user journey test script, according to some embodiments.

FIG. 3E is an example of an API management GUI displaying an API dependency map, according to some embodiments.

FIG. 4A is an example of an API management GUI displaying the status view of a parent API and/or API dependency from the API dependency map within a user journey test script, according to some embodiments.

FIG. 4B is an example of an API management GUI displaying the request payload of a parent API and/or API dependency from the API dependency map within a user journey test script, according to some embodiments.

FIG. 4C is an example of an API management GUI displaying a response to an API request of a parent API and/or API dependency from the API dependency map within a user journey test script, according to some embodiments.

FIG. 5 is a flowchart illustrating a method for API dependency mapping, according to some embodiments.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for API dependency mapping. With the increase of an API economy, enterprises are managing and monitoring potentially hundreds and thousands of APIs to deliver services to its users. Accordingly, testing engineers can monitor and identify individual APIs. Oftentimes, when an API is unavailable, the unavailability may be due to an API call downstream rather than a coding error within an individual API. As a result, some user journeys may be impacted due to the unavailability of several dependent APIs. However, existing API management systems are unable to bridge the gap between API management and user journeys by only providing a mechanism to monitor individual APIs. Therefore, a technological solution is needed to bridge the gap between user journeys and API management and provide an API dependency mapping of a user journey.

To perform the validation and/or testing of APIs across user journeys, one or more user journeys may be defined using one or more test scripts. A user journey may reflect a sequence of user actions performed to achieve a particular goal involving the access of multiple APIs. The user journey may include front-end graphical user interface (GUI) interactions that cause back-end processing performed to achieve the goal. Thus, during execution, the user journey may invoke a sequence of APIs.

For example, an example user journey may be for a user to access a user bank account to view balance information. The particular user journey may include accessing a bank webpage; supplying user credentials on the bank webpage; checking the user credentials on the back-end using an identity management application; performing a two-factor authentication; retrieving the bank account information for display; generating a web browser display including the bank account information; logging out of the bank webpage; accessing a mobile application for the bank; re-supplying user credentials in the mobile application; performing a biometric verification of the user; retrieving the bank account information again; and/or displaying the bank account information within the mobile application. This example user journey may interface with different types of APIs to perform this sequence of interactions. For example, the retrieval of bank account information may be executed by an application that interfaces with an API that differs from another application that interfaces with an API for enabling performing two-factor authentication or biometric verification.

Many user journeys may occur in practice and be captured using different test scripts. These test scripts may simulate hundreds or thousands of different user journeys through potentially hundreds or thousands of APIs monitored by an API management system. Using the API management system, a testing engineer may monitor sequences of APIs to ensure that user journeys are successfully executed. To perform this testing, an API management system may generate one or more GUIs allowing a testing engineer or user to define one or more test scripts corresponding to different user journeys to monitor different APIs. The GUIs may display a dependency mapping view flowing from a test script.

The API management tool may enable a test engineer to register APIs. A test engineer may then create a test script corresponding to a user journey. The test script may contain a map of a sequence of API dependencies within a user journey. The sequential map may comprise visual objects corresponding to parent APIs, and for each parent API, the sequential map comprises visual objects representing dependent APIs called from the parent APIs. This mapping provides a comprehensive narrative of the user journey.

Accordingly, a test engineer can then execute the test script to determine at which point within the user journey an API or dependent APIs therefrom are unavailable and impacting the user journey. Accordingly, the API management system compiles analytics corresponding to API errors and/or unavailability. These analytics aid in identifying and diagnosing unavailable APIs and APIs downstream within a user journey. The detection of this unavailability across multiple APIs and/or a sequence of APIs provides increased accuracy in identifying unavailable APIs within a user journey.

The API management system may also inform the particular application development team or developers managing the unavailable APIs. For example, if different teams of developers are responsible for managing different APIs, the API management system may notify or alert the relevant team as to the unavailability of the API. This notification may occur in real-time, even if a particular test script is still in the process of executing.

In this manner, the API management system may allow testing engineers to build user journeys as test scripts to monitor multiple APIs and/or a sequence of APIs. The API management system may also allow testing engineers to define a polling interval corresponding to the execution of the one or more test scripts. This polling interval may define a time interval for executing the test scripts. The test execution engine may track errors and/or statistics related to the execution of the test scripts at these intervals. For example, the API management system may view the status, the request payload, and/or responses of APIs within the API dependency map for particular user journeys.

As previously explained, these processes may increase the efficiency of API management. This gathering of statistics and/or error reports may aid testing engineers in sending alerts to teams managing unavailable APIs. This dependency mapping view will also bridge the gap between user journeys and APIs by providing test engineers visual mapping of how particular APIs are impacting a user journey. By mapping APIs used in sequence within a user journey, testing engineers may more efficiently identify which user journeys are unable to execute due to an API's unavailability. Accordingly, testing engineers can more easily identify how APIs impact a user journey, and as a result, allow enterprises to deliver a more seamless user experience.

Various embodiments of these features will now be discussed with respect to the corresponding figures.

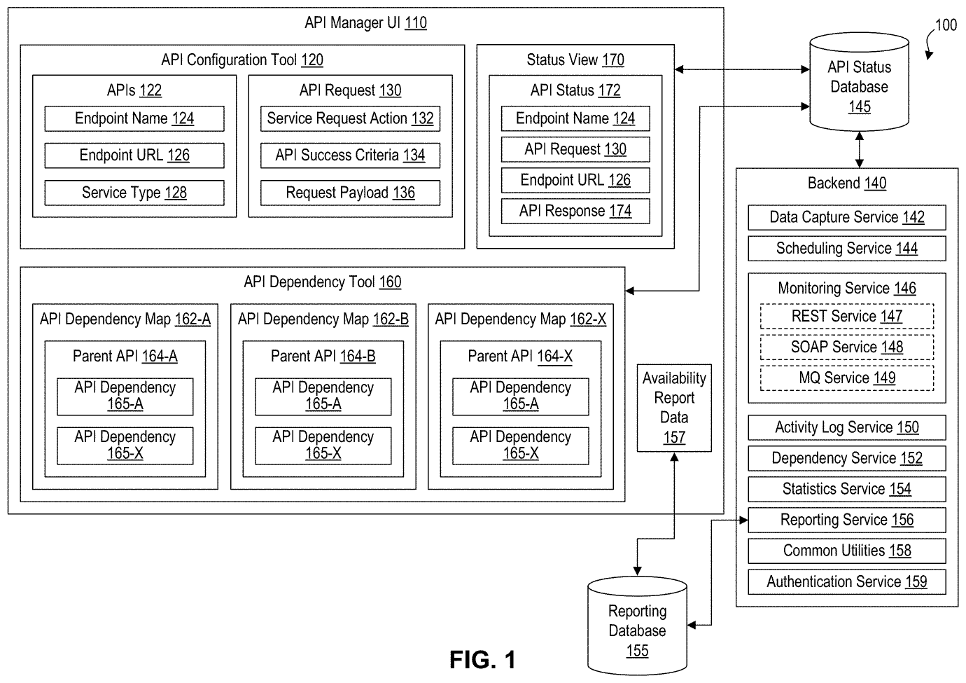

FIG. 1 is a block diagram illustrating a system architecture for API dependency mapping, according to some embodiments. API management system 100 may include an API manager UI 110, API status database 145, backend 140, reporting database 155, and/or a network or combination of networks (not shown), including the internet, a local area network (LAN), a wide area network (WAN), a wireless network, a cellular network, or various other types of networks, as would be appreciated by a person of ordinary skill in the art. API manager UI 110, API status database 145, backend 140, and/or reporting database 155, connected together through one or more networks.

API manager UI 110 may include API configuration tool 120, API dependency tool 160, status view 170, and/or API availability report 157. API manager UI 110 may be a graphical user interface through which the user interacts with the tools and services provided through API manager UI 110. API manager UI 110 may include a front-end application or user interface component that displays various tools, data, and services for API dependency mapping. API manager UI 110 may be a client program, desktop application, native application, mobile application, or other interactive display. In an embodiment, API manager UI 110 may include a program that is executing on one or more servers and is receiving and processing requests, including data updates, from more than one API management system 100 across a plurality of user devices. API manager UI 110 may manage various applications and APIs managed or accessed by an enterprise and/or user.

APIs may be configured within API manager UI 110 at set intervals. API configuration tool 120 may include APIs 122 and API request 130. A provider may configure APIs 122 within API configuration tool 120. APIs 122 may facilitate requests to one or more operating systems and/or applications included in or coupled to API manager UI 110. In one configuration, APIs 122 may be exposed to one or more business intelligence systems. These business intelligence systems may include various databases, systems, and tools. APIs 122 may facilitate requests to various applications managed by the same or separate entities. For example, APIs 122 may facilitate interaction between API manager UI 110 and one or more applications managed by the same or separate entities.

A testing engineer can register APIs 122 to be monitored by API manager UI 110 by defining various characteristics of APIs 122. For example, a testing engineer may configure APIs 122 by defining an endpoint name 124 and endpoint URL 126. To integrate two software applications, an endpoint can be exposed by one of the two software applications. Endpoint URL 126 can be a uniform resource locator (URL) that represents a network location of where the API is accessible.

Interfacing or interconnection among various systems and layers may employ any number of mechanisms, such as any number of protocols, programmatic frameworks, or application programming interfaces (API). A user may configure APIs 122 by specifying a service type 128, including, but not limited to, JSON (JavaScript Object Notation), Representational State Transfer (REST or RESTful web services), Extensible User Interface Protocol (XUP), Simple Object Access Protocol (SOAP), XML Schema Definition (XSD), XML Remote Procedure Call (XML-RPC), Message Queue (MQ), or any other service protocols known to a person of ordinary skill in the art.

In addition to registering APIs 122, a testing engineer may register API request 130 corresponding to APIs 122 within API manager UI 110. For example, a testing engineer may configure API request 130 by specifying service request action 132, API success criteria 134, request payload 136, and/or other information relevant to API request 130. API manager UI 110 may send requests to various servers to complete an action associated with APIs 122. Service request action 132 may be processes, programs, functions, and/or actions a server calls based on the endpoint URL 126 defined for particular APIs 122 in API configuration tool 120. Service request action 132 may be used to indicate the intent of a particular service request. Service request action 132 may include CRUD (Create, Read, Update, Delete) operations for creating and consuming data in API manager UI 110 for a user journey.

A user may define API success criteria 134 to determine whether an API is running properly. API success criteria 134 may include, but is not limited to, latency, response time, status codes, failure rates, etc. For example, REST-based protocols may use various status codes to determine API success. An HTTP response message may include a status code of 200 to indicate an API request 130 sent from API manager UI 110 was accepted successfully. On the other hand, an HTTP response message may return a status code of 500, which indicates the server is responsible for an error associated with a particular API request 130 sent from API manager UI 110.

A user may also define the request payload 136 for API request 130. Request payload 136 may include data API manager UI 110 sends to the server when sending an API request 130 for APIs 122. Request payload 136 may include parameters and body data to send to servers managing APIs as part of API request 130. Any applicable data structures, file formats, and schemas may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

API manager UI 110 may store the registered APIs 122 within a list with the relevant information regarding APIs 122 and API request 130. Any of the above API request 130 for APIs 122 may interface with or be implemented in any programming language, procedural, functional, or object-oriented, and may be compiled or interpreted. Non-limiting examples include C, C++, C#, Objective-C, Java, Swift, Go, Ruby, Perl, Python, JavaScript, WebAssembly, or virtually any other language, with any other libraries or schemas, in any kind of framework, runtime environment, virtual machine, interpreter, stack, engine, or similar mechanism, including but not limited to Node.js, V8, j Query, Dojo, Dijit, OpenUI5, AngularJS, Express.js, Backbone.js, Emberjs, DHTMLX, React, Electron, among many other non-limiting examples.

Backend 140 may be configured to process requests for API manager UI 110. API manager UI 110 may receive captured run-time information of configured APIs from backend 140. Backend 140 may include services including, but not limited to, data capture service 142, scheduling service 144, monitoring service 146, activity log service 150, dependency service 152, statistics service 154, reporting service 156, common utilities 158, and/or authentication service 159. Backend 140 may be designated to handle process API requests 130 submitted through API configuration tool 120. Backend 140 may operate across a plurality of machines or servers and manage received data across a plurality of machines or servers to manage APIs 122.

Backend 140 may capture data from endpoints in a user journey using data capture service 142. Data capture service 142 may be an input micro service for creating, updating, reading, and deleting various APIs 122, applications, and/or platforms managed by API management system 100. Data capture service 142 may use a Spring Boot configuration. Data capture service 142 may retrieve information regarding APIs 122. Data capture service 142 may transmit the information related to the APIs 122 to monitoring service 146.

Backend 140 may use monitoring service 146 to monitor various APIs 122. Monitoring service 146 may be a micro service that executes APIs 122 configured in API configuration tool 120. Depending on the service type 128 selected in configuration tool 120 for particular APIs 122, backend 140 may use monitor REST service 147, monitor SOAP service 148, and/or monitor mq service 149, according to some embodiments. Backend 140 may use any monitoring service 146 compatible with any service type 128 known to a person of ordinary skill in the art used to monitor APIs.

Monitor REST service 147 may be a micro service used to execute APIs 122 configured within the configuration tool 120 as a REST-based service type 128. Monitor REST service 147 may implement different authentication methods, including, but not limited to, HMAC, JWT, OAuth, Auth blue, SiteMinder, custom security token, etc. Monitor SOAP service 148 may be a micro service used to execute APIs 122 configured within the configuration tool 120 as a SOAP-based service type 128. Monitor SOAP service 148 may implement different authentication methods, including, but not limited to, LDAP, custom security token, message signing, etc.

Backend 140 may be designated to schedule when API requests 130 will be processed and/or monitored. Scheduling service 144 may be a service for scheduling when APIs 122 will be processed and/or monitored. Scheduling service 144 may schedule APIs 122 based on a polling interval. Scheduling service 144 may send the API requests 130 to monitoring service 146. Scheduling service 144 may send API requests 130 based on the API service type 128.

Backend 140 may store activity data for APIs 122 in an activity log. Activity log service 150 may retrieve information related to APIs 122 from monitoring service 146. Activity log service 150 may be a micro service used to store an activity log including, but not limited to, activity data of APIs 122. The activity data may include the status of APIs 122. For example, for REST-based APIs, an HTTP response message may include standard status codes as follows: a status code designated “2XX” indicating API request 130 was accepted successfully; a status code designated “3XX” indicating API management system 100 may need to take additional action to complete API request 130; a status code designated “4XX” indicating the error is caused by API management system 100; and a status designated “5XX” indicating the error is caused by the server managing the relevant API 122. However, depending on API success criteria 134 and/or the service type 128 of APIs 122, the status of APIs 122 may be represented in a different manner and include additional information.

Activity log service 150 may store the activity log containing activity data of APIs 122 in API status database 145. Activity log service 150 may retrieve the activity data of APIs 122 in the activity log and display the activity data in API manager UI 110. Backend may use dependency service 152. Dependency service 152 may enable the creation and management of dependency maps containing APIs 122. Dependency service 152 may provide the status of each of the APIs 122 within a user journey in a dependency map. Dependency service 152 may use the activity data from the activity log stored in API status database 145 to provide the status of APIs 122 in a dependency map.

Backend 140 may use various services to gather statistics and/or error reports to aid test engineers in sending alerts to teams managing unavailable APIs. Backend 140 may use statistics service 154, reporting service 156, and/or common utilities 158 to provide analytics and alerting functionalities for the APIs 122 managed in API manager UI 110. Statistics service 154 may be a micro service configured to retrieve statistical data for various platforms, applications, and APIs 122 managed by API manager UI. Statistical data may include, but is not limited to, percentages of available and unavailable APIs 122 for each entity managing APIs 122, percentage of APIs 122 corresponding to each status code returned in API response 174, etc.

Reporting service 156 may be a micro service configured to provide reporting data regarding APIs 122. Reporting service 156 may retrieve activity data from the activity log stored in API status database 145. Reporting service may store reporting data regarding APIs 122 within reporting database 155. API manager UI 110 may display the reporting data retrieved from reporting database 155 in API availability report 157. The reporting data may include, but is not limited to, whether or not each of APIs 122 are available. Backend 140 may use common utilities 158 to alert other teams. Common utilities 158 may be a utility service configured to send incident notifications regarding unavailable APIs 122. For example, common utilities 158 may be configured to send a notification to a system administrator when an API 122 is determined to be unavailable.

Backend 140 may provide login credentials to an authentication service 159 to authenticate a user's credentials. Authentication service 159 may be a micro service configured to authenticate and/or authorize a user to perform certain operations within API manager UI 110. Authentication service 159 may use authentication techniques known to a person of ordinary skill in the art to authenticate the user's login credentials.

After registering APIs 122 within configuration tool 120, monitoring service 146 executes API request 130 and validates the results against API success criteria 134. A user may then configure an API dependency map to connect particular APIs 122 to service a user journey. An API dependency map provides a comprehensive view of all API dependencies in a user journey within API manager UI 110. API manager UI 110 includes API dependency tool 160, which enables the creation of one or more API dependency maps 162 (API dependency map 162-A, API dependency map 162-B, . . . , API dependency map 162-X).

User journey test script 163 (not shown) may represent test scripts corresponding to different user journeys to monitor different APIs in a particular user journey. API dependency map 162 may be a visual representation of user journey test script 163 and parent APIs 164 and API dependencies 165 flowing therefrom within a user journey. API dependency map 162 may comprise a sequential map of visual objects. The sequential map may illustrate (1) each of the parent APIs 164 specified in the user journey test script 163 and (2) for each of the parent APIs 164, any dependent API 165 called by the respective parent API 164.

API dependency tool 160 enables a user to create an API dependency map 162 by connecting parent APIs 164 (parent API 164-A, parent API 164-B, . . . , parent API 164-X) and API dependencies 165 (API dependency 165-A, API dependency 165-B, . . . , API dependency 165-X) involved in servicing a user journey. A user may also add and remove objects representing parent APIs 164 and API dependencies 165 from API dependency map 162. Parent APIs 164 represent the initial APIs 122 called when servicing a user journey. API dependencies 165 represent APIs 122 called downstream from parent APIs 164 when servicing a user journey. For example, in API dependency map 162-A, the first parent API 164 may call API dependency 165-B, which may then in turn call API dependency 165-C. API dependencies 165 may continue to call API dependencies downstream until the test script has executed through the entire user journey.

After executing the test script corresponding to API dependency map 162, a user may view the status of parent APIs 164 and API dependencies 165 within API dependency map 162. API manager UI 110 may include a status view 170 that provides the API status 172 of APIs 122 corresponding to the parent APIs 164 and API dependencies 165 in API dependency map 162. API status 172 may include the endpoint name 124, API request 130, and/or endpoint URL 126 corresponding to APIs 122 within API dependency map 162. API status 172 may also include API response 174, which is the returned API response corresponding to the API request 130 of APIs 122 within API dependency map 162. Status view 170 may communicate with dependency service 152 to generate API status 172. Status view 170 may retrieve data from dependency service 152 to generate the status of the parent APIs 164 and API dependencies 165 within API dependency map 162.

As a result, dependency map 162 and status view 170 provide a holistic view of API availability through a user journey. In this one view, testing engineers can determine whether all APIs 122 corresponding to parent APIs 164 and/or API dependencies 165 in a user journey are running or whether any APIs 122 are failing, which will result in the user journey failing. If a user journey experiences disruption, a user may use the view of the API dependency map 162 to quickly identify unavailable APIs 122 in the user journey. This quick identification of unavailable APIs 122 enables test engineers to expedite pinpointing the root cause of unsuccessful user journeys, and thereby, significantly reduces the outage duration.

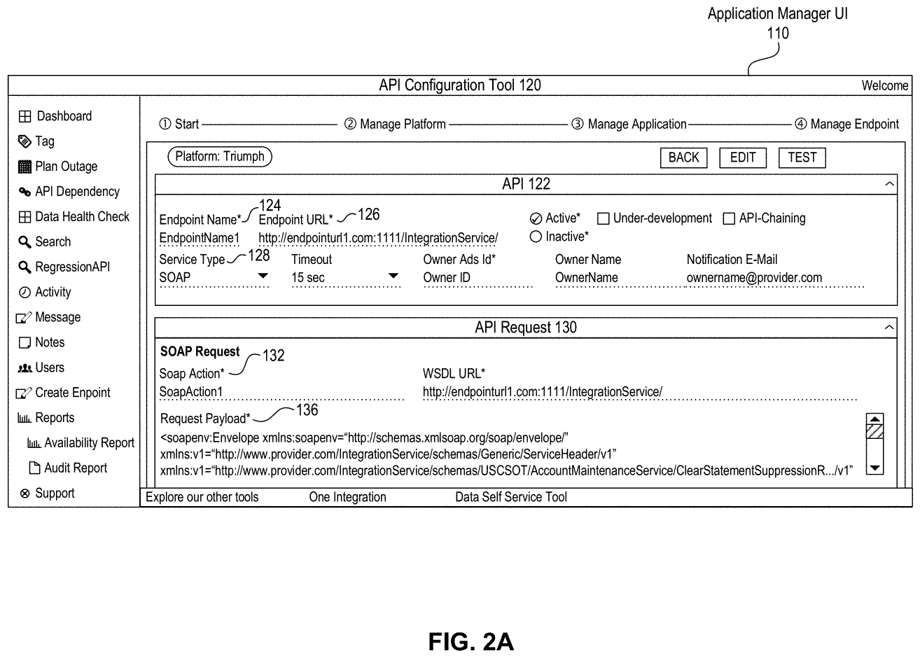

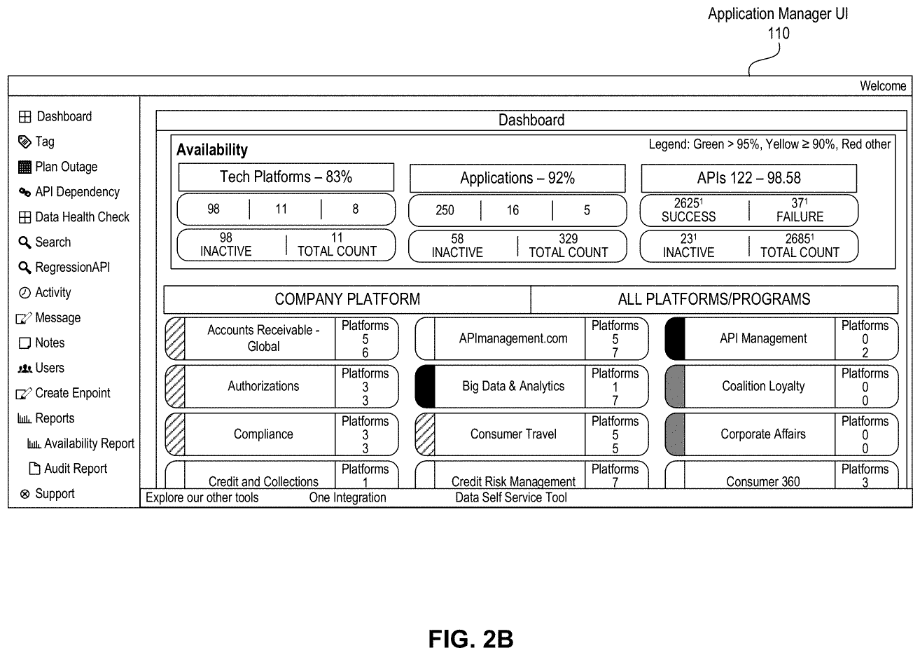

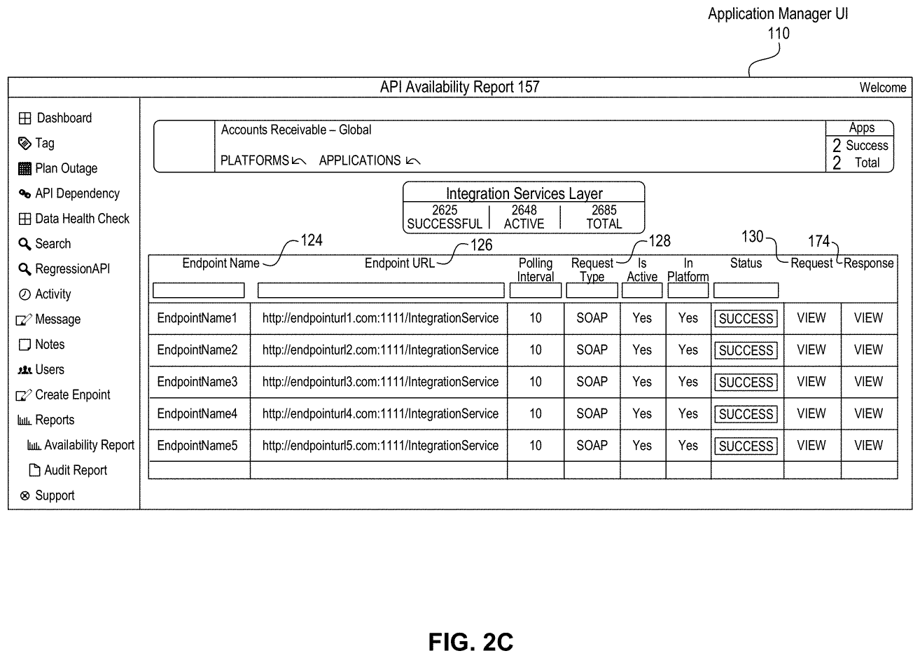

FIG. 2A is an example of API manager UI 110 displaying an API configuration tool 120 for configuring APIs 122, according to some embodiments. FIG. 2 is described with reference to FIG. 1. To illustrate the implementation of API dependency mapping, an example is provided illustrating various tools in API manager UI 110. Here, API manager UI 110 displays configuration tool 120 for configuring APIs 122. As shown, API manager UI 110 enables a user to configure APIs 122 by providing general information about APIs 122 and the corresponding API request 130.

A user may provide general information regarding the APIs, including, but not limited to, endpoint name 124, endpoint URL 126, service type 128, activation status, timeout, owner name, notification e-mail, etc. Here, the user named the endpoint name 124 “EndpointNamel” and defined the endpoint URL 126 as “http://endpointurl1.com:1111/IntegrationService/”. Moreover, this particular API 122 is a SOAP-based API, and thereby, the user designated the service type 128 as “SOAP” within configuration tool 120.

Additionally, the user may configure API request 130, which may include, but is not limited to, a service request action 132, API success criteria 134, and/or request payload 136 within configuration tool 120. Here, the user defined the service request action 132 as “SoapAction1,” an action to be performed by the selected SOAP-based API defined in the general information section of configuration tool 120. The user has also defined the request payload 136, which includes the data sent as part of API request 130. After the user configures APIs 122 within configuration tool 120, backend 140 invokes the configured APIs 122.

Backend 140 may use data capture service 142 to retrieve information regarding the endpoint URL 126 from API status database 145. After retrieving this information from API status database 145, data capture service 142 transmits the information related to APIs 122 to monitoring service 146.

Depending on the service type 128 selected in configuration tool 120 for particular APIs 122, backend 140 may use monitor REST service 147, monitor SOAP service 148, and/or monitor MQ service 149, according to some embodiments. Here, the user selected “SOAP” as the service type 128. Accordingly, backend 140 uses monitor SOAP service 148 to execute the SOAP-based API 122 configured within the configuration tool 120. Monitor SOAP service 148 may implement different authentication methods, including, but not limited to, LDAP, custom security token, message signing, etc.

Backend 140 may also use scheduling service 144 to schedule when APIs 122 will be processed and/or monitored based on a polling interval. Referring to FIG. 2C, the polling interval for the selected API 122 is 10 seconds. Therefore, based on the polling interval value the user configured, scheduling service 144 schedules the selected monitors API 122 every ten seconds using monitor SOAP service 148. Accordingly, monitor SOAP service 148 invoked API 122 at the ten-second defined interval to validate the results against API success criteria 134 defined within request payload 136.

After the user configures APIs 122 within API configuration tool 120 and backend 140 invokes APIs 122, API manager UI 110 may display the activity data corresponding to APIs 122. Referring to FIG. 2B, this example provides a dashboard of an API management system 100 displaying analytics of various platforms, applications, and services, according to some embodiments. API manager UI 110 displays a dashboard containing all the platforms, applications, and APIs 122 managed by API manager UI 110. With the increase of an API economy, enterprises may manage and monitor potentially hundreds and thousands of APIs to deliver services to its users. As shown, API manager UI 110 manages 329 applications and 2,685 APIs 122.

As shown in FIG. 2C, API manager UI 110 enables a user to view the status of individual APIs 122 within API availability report 157. Backend 140 may monitor activity data for APIs 122 using an activity log. Activity log service 150 retrieves the activity data of APIs 122 and displays the activity data in API manager UI 110. Reporting service 156 retrieves activity data from the activity log generated by activity log service 150. Reporting service then stores reporting data regarding API 122 within reporting database 155. API manager UI 110 displays the reporting data retrieved from reporting database 155 in API availability report 157. As shown, for each of the APIs 122, the API availability report 157 includes a table of the endpoint name 124, endpoint URL 126, polling interval, request type, API status 172, API request 130, and/or API response 174.

Therefore, users are able to determine whether an individual API is unavailable based on the “status” column shown in FIG. 2C. However, as API manager UI 110 manages thousands of APIs 122, it is difficult to view the API status 172 of each of the APIs 122 within the context of a user journey. Furthermore, the unavailability of an individual API may further impact other APIs or create additional downstream unavailability when multiple APIs are used in a sequence. Because a user can only manage and monitor individual APIs 122 among thousands of APIs 122, it is difficult to assess the impact of a particular API and API dependencies therefrom in a user journey. Therefore, a technological solution is needed to bridge the gap between user journeys and API management and provide a holistic and comprehensive view of an API dependency mapping of a user journey.

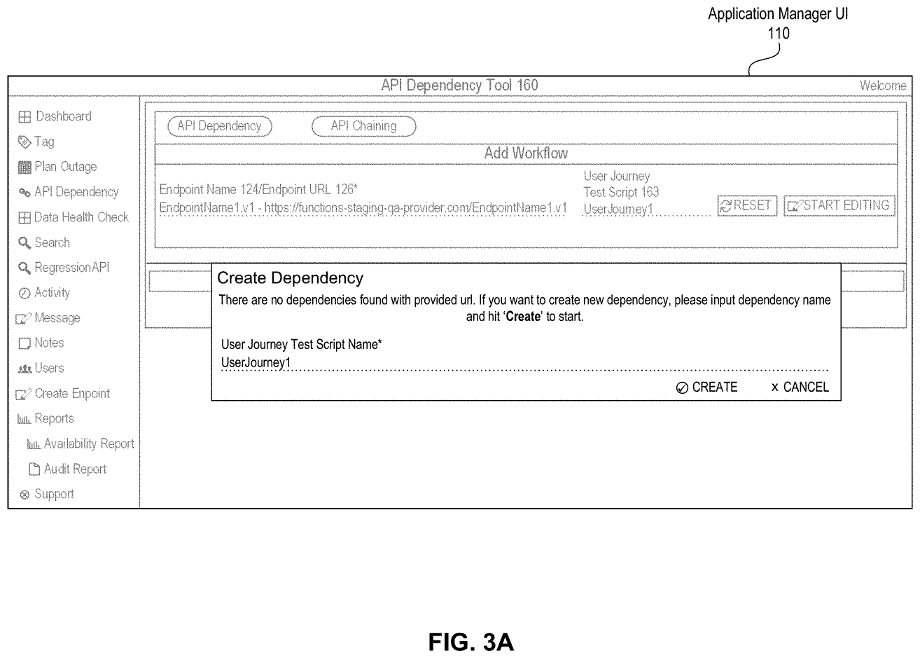

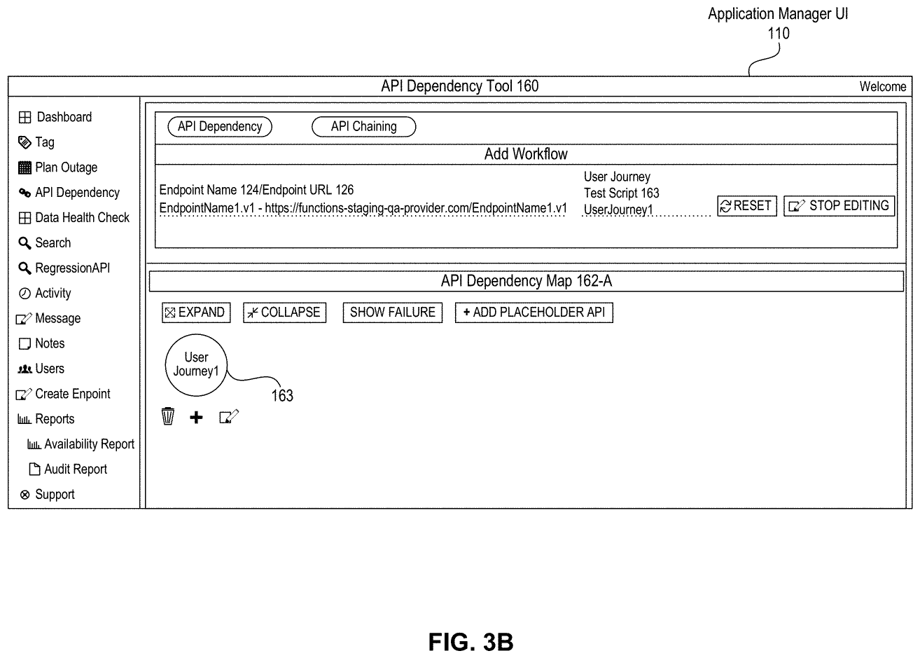

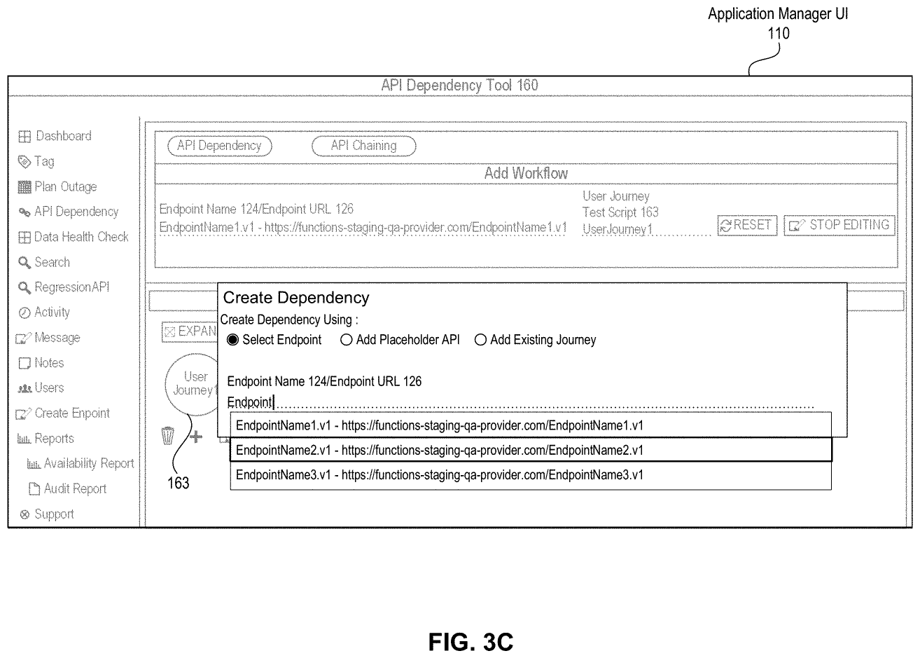

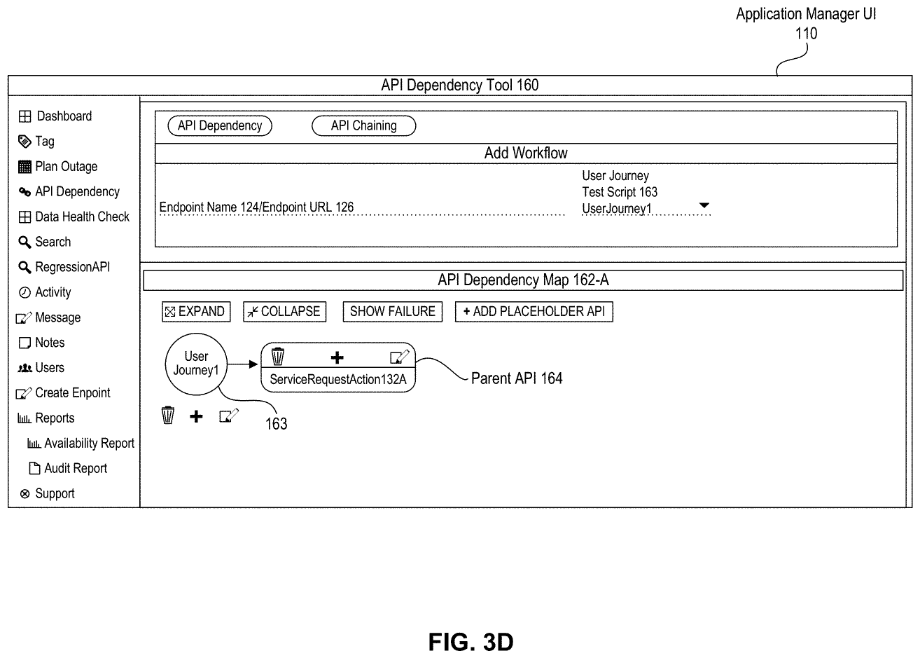

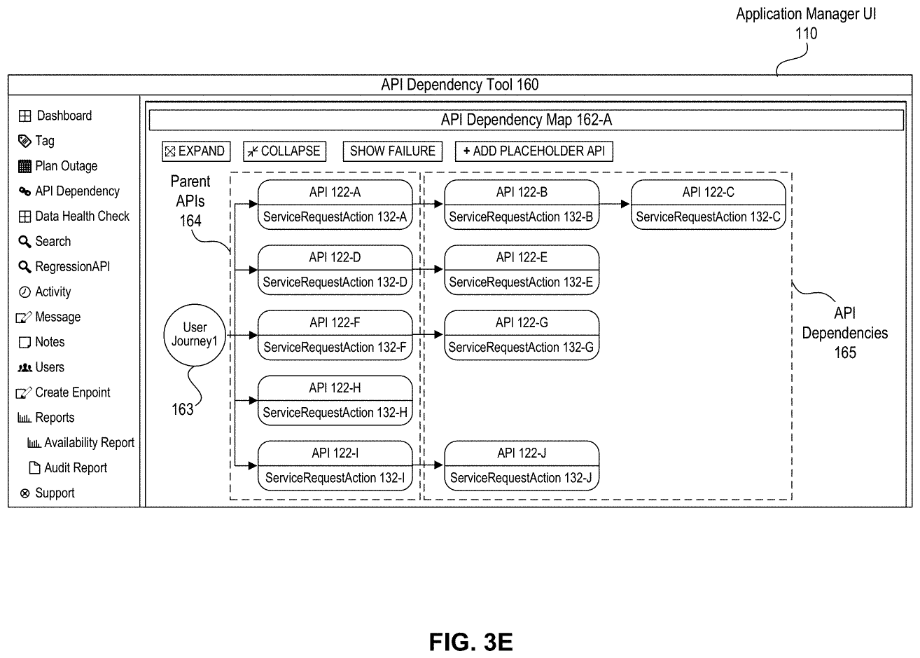

FIGS. 3A and 3B are examples of API manager UI 110 displaying an API dependency tool 160 used to create a user journey test script 163, according to some embodiments. FIG. 3 is described with reference to FIG. 1 and FIG. 2. While existing API management systems can invoke and monitor individual APIs, these systems do not provide a comprehensive view of all API dependencies within one holistic view. In addition, these existing API management systems do not support a variety of services, i.e., connecting REST, SOAP, and MQ APIs. Therefore, a technological solution is needed to bridge the gap between API management and user journeys through API dependency mapping. An API dependency map will enable a user to identify the unavailable APIs and API dependencies therefrom causing a user journey to fail.

As shown in FIG. 3A, API manager UI 110 displays an API dependency tool 160 for enabling the creation and management of an API dependency map 162. API dependency tool 160 may generate one or more GUIs allowing a user to define one or more test scripts corresponding to different user journeys to monitor different APIs. Here, in order to create user journey test script 163, the user named the user journey test script 163 as “CustomerJourney1.” Once the user creates the user journey test script 163, an object populates within API dependency map 162 that represents user journey test script 163. As shown in FIG. 3B, the user journey test script 163 named “CustomerJourney1” is the initial object within the dependency map 162-A that is used to execute user journey test script 163. The user may select the “+” sign underneath the object representing user journey test script 163 to add a parent API 164.

As shown in FIG. 3C, the user may be prompted to input the endpoint name 124 and endpoint URL 126 for the relevant parent API 164 corresponding to APIs 122 in the user journey. Here, the user selected “select endpoint” and inputted the endpoint name 124 and endpoint URL 126 as “EndpointName1.v1—http://functions-staging-qa-provider.com/EndpointName1.v1.” After the endpoint is selected, as shown in FIG. 3D, an object representing parent API 164 populates within API dependency map 162. The object representing parent API 164 is connected to the object representing user journey test script 163. As a result, this represents the flow of the APIs accessed within an end-to-end user journey.

As shown in FIG. 3D, the user may add an API dependency 165 (not shown) by clicking the “+” sign above the first parent API 164 within user journey test script 163. The user may add the subsequent API dependency 165 within the user journey using the same process as the parent API 164. The user would again select the relevant endpoint corresponding to the desired API 122. The API dependency 165 would then populate as an object representing the API dependency 165 flowing downstream from parent API 164 accessed in the user journey. The user repeats this process until all the parent APIs 164 and API dependencies 165 in the user journey are added to API dependency map 162.

As shown in FIG. 3E, the user added five parent API 164 corresponding to API 122-A, API 122-D, API 122-F, API 122-H, and API 122-I to API dependency map 162-A. For parent API 122-A, the user added two API dependencies 165 corresponding to API 122-B and API 122-C. For parent API 122-D, API 122-F, and API 122-I, the user added one API dependency 165 corresponding to API 122-E, API 122-G, and API 122-J, respectively. Each of the objects representing the API dependencies 164 may contain information identifying the corresponding API 122 and service request action 132 to provide to the user a clear narrative of the user journey. FIG. 3E presents the resulting API dependency map 162 once the user has added all parent APIs 164 and API dependencies 165 accessed in the user journey.

After the user builds a complete API dependency map 162, API manager UI 110 may receive a request from the user to execute user journey test script 163 to validate the user journey. Here, as a result of executing the user journey test script 163 for “UserJourney1,” API 122-A calls API 122-B and API 122-B calls API 122-C; API 122-D calls API 122-E; API 122-F calls API 122-G; and API 122-I calls API 122-J. If certain APIs 122 and dependent APIs therefrom are unavailable, the dependency map 162 may visually indicate which APIs 122 are unavailable. For example, the object of parent API 164 and/or API dependency 165 representing an unavailable API 122 may be outlined as red. This may distinguish the unavailable APIs 122 from other available APIs 122 within the dependency map 162, which would allow the user to quickly identify which APIs 122 in the user journey are experience outage. By providing a holistic and comprehensive view of the user journey, dependency map 162 expedites identification of the root cause, and thereby, significantly reduces the duration of the outage.

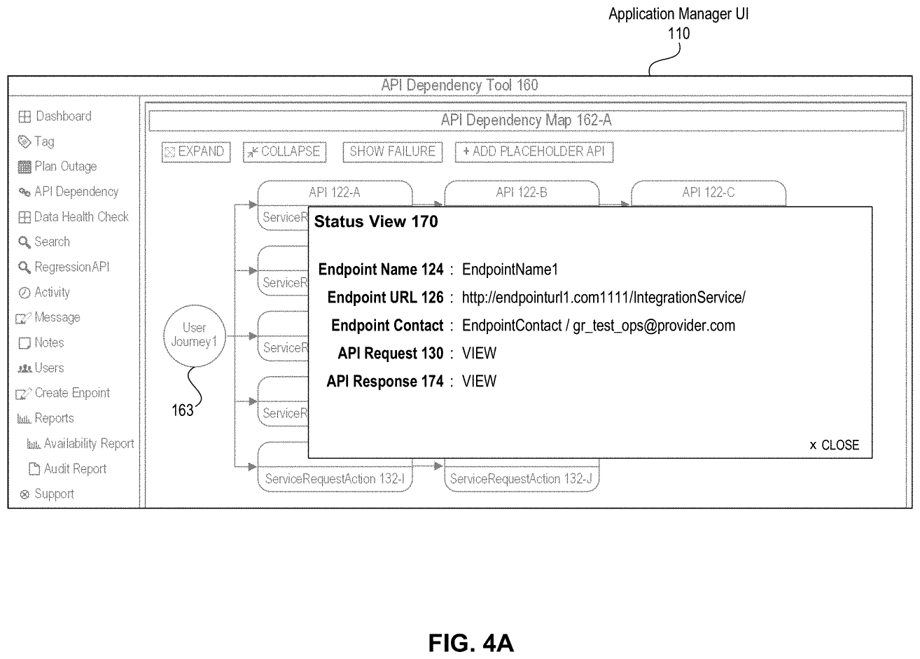

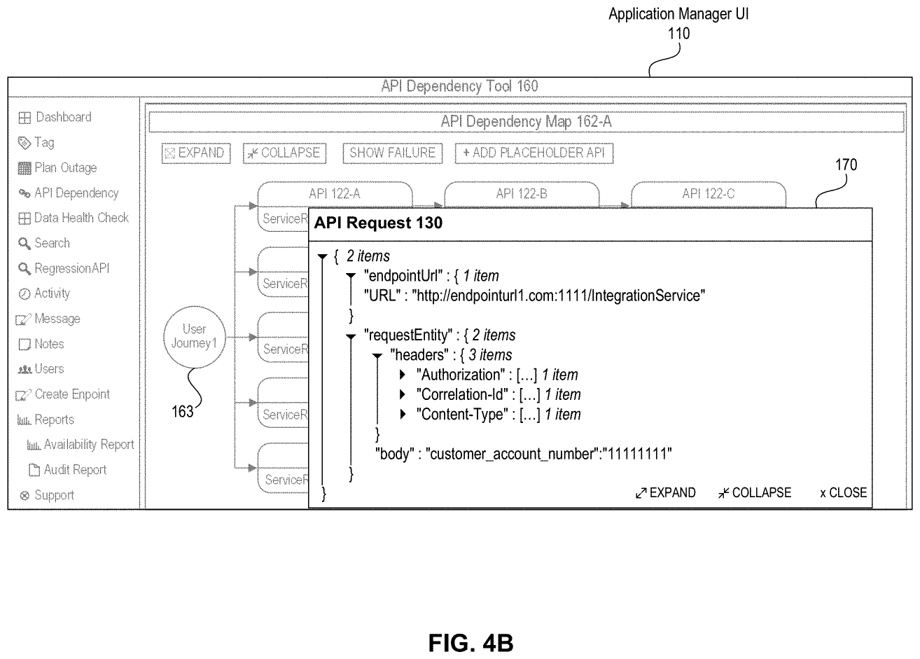

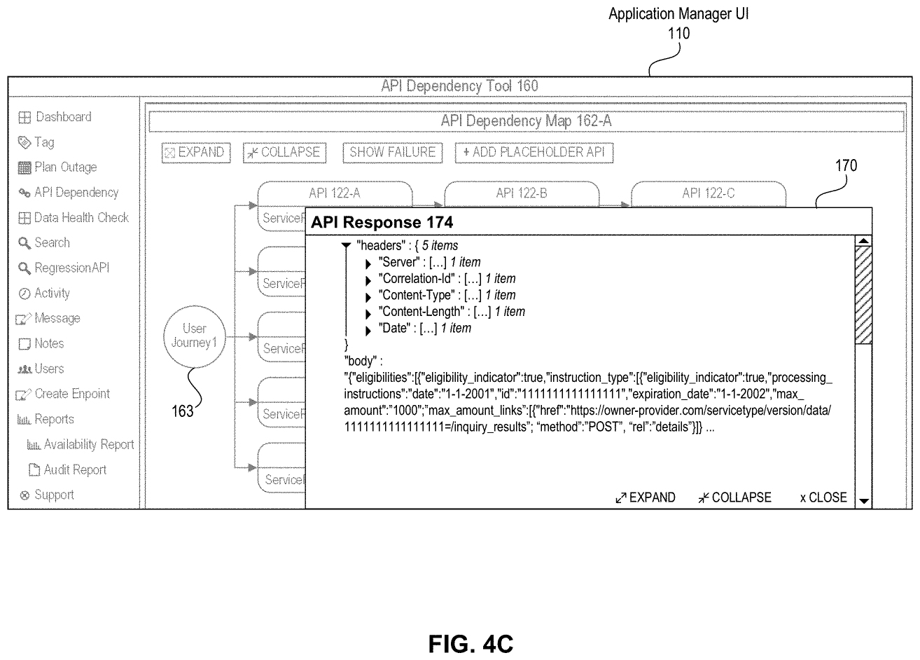

FIG. 4A is an example of API manager UI 110 displaying the status view 170 of a parent API 164 and/or API dependency 165 from the API dependency map 162 within a user journey test script 163, according to some embodiments. FIG. 4 is described with reference to FIGS. 1-3. As discussed in reference to FIG. 3E, API dependency map 162 displays the current status of each of the APIs 122. To enable users to determine which APIs are impacting a user journey, the unavailable APIs 122 are clearly identified. As shown in FIG. 4A, the user can select any parent API 164 and/or API dependency 165 in API dependency map 162 to view the status of the corresponding APIs 122. Once the user selects a parent API 164 and/or API dependency 165 within API dependency map 162, API manager UI 110 displays status view 170 containing the API status 172 of the corresponding APIs 122.

Here, as an example, status view 170 displays the API status 172 of an API 122 in “UserJourney1.” The status view 170 displays the endpoint name 124, endpoint URL 126, endpoint contact, API request 130, and/or API response 174. Status view 170 displays the general information for the corresponding API 122 wherein the user defined endpoint name 124 as “EndpointName1” and defined the endpoint URL 126 as “http://endpointurl1.com:1111/IntegrationService/”. Status view 170 also displays the endpoint contact as “EndpointContact/gr_test_ops@provider.com.” Using common utilities 158, backend 140 may report analytics data related to the unavailable API 122 to the relevant endpoint contact.

The user may also view API request 130. As shown in FIG. 4B, the user can view the request payload 136 corresponding to the API request 130 for the relevant APIs 122. The user can view the headers and the data parameters contained within the request payload 136 corresponding to API request 130. Moreover, as shown in FIG. 4C, API manager UI 110 displays to the user the API response 174 corresponding to API request 130. API response 174 can include the results of API request 130 outlined within request payload 136, a value indicating whether API request 130 successfully executed, and/or any errors or message warnings, etc. As a result, the user can quickly identify the root cause of any unavailable APIs by quickly accessing the API status 172 containing the relevant information related to the unavailable API 122, the API request 130, and/or API response 174.

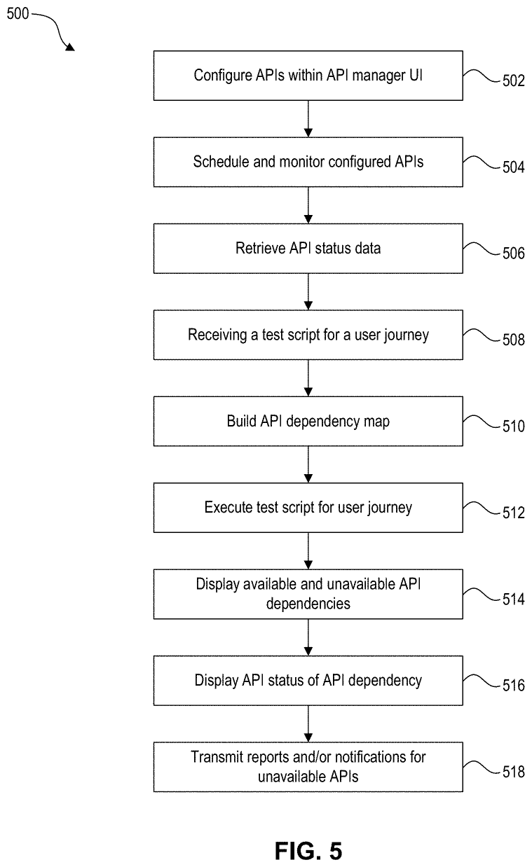

FIG. 5 is a flowchart illustrating a method for API dependency mapping, according to some embodiments. FIG. 5 is described with reference to FIGS. 1-4. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

At 502, API manager UI 110 retrieves a request to configure APIs 122 in API configuration tool 120. A user configures APIs 122 within API manager UI 110 at set intervals. API configuration tool 120 may include APIs 122 and API request 130. A user configures APIs 122 within API configuration tool 120. APIs 122 facilitate requests to one or more operating systems and/or applications included in or coupled to API manager UI 110. In one configuration, APIs 122 are exposed to one or more same or separate entities.

A user then further configures APIs within API manager UI 110 by defining various characteristics of APIs 122. The user configures APIs 122 by defining an endpoint name 124 and endpoint URL 126. To integrate two software applications, an endpoint can be exposed by one of the two software applications. Endpoint URL 126 can be a uniform resource locator (URL) that represents a set of data and services accessible using an API from a software application.

In addition to configuring APIs 122, a user configures API request 130 corresponding to APIs 122 within API manager UI 110. For example, a user configures API request 130 by specifying service request action 132, API success criteria 134, request payload 136, and/or other information relevant to API request 130. API manager UI 110 may send requests to various servers to complete an action associated with APIs 122. Service request action 132 may be processes, programs, functions, and/or actions a server calls based on the endpoint URL 126 defined for particular APIs 122 in API configuration tool 120. Service request action 132 may be used to indicate the intent of a particular service request. Service request action 132 may include CRUD (Create, Read, Update, Delete) operations for creating and consuming data in API manager UI 110 for a user journey.

As part of API request 130, a user defines API success criteria 134, if applicable, to determine whether an API 122 is running properly. API success criteria 134 may include, but is not limited to, latency, response time, status codes, failure rates, etc. Additionally, as part of API request 130, a user defines the request payload 136 for API request 130. Request payload 136 may include data API manager UI 110 sends to the server when making API request 130 for APIs 122. Request payload 136 may include parameters and body data to send to servers managing APIs 122 as part of API request 130.

At 504, API manager UI 110 transmits a request to schedule and monitor the APIs 122 configured in API configuration tool 120. Backend 140 is configured to capture data from endpoints in a user journey using data capture service 142. Data capture service 142 creates, updates, reads, and deletes various APIs 122, applications, and platforms managed by API management system 100. Data capture service 142 retrieves information regarding APIs 122. Data capture service 142 transmits the information related to the APIs 122 to monitoring service 146.

Scheduling service 144 schedules when API request 130 for APIs 122 will be processed and/or monitored. Scheduling service 144 schedules processing and monitoring API request 130 based on a polling interval. Scheduling service 144 sends the API requests 130 to monitoring service 146. Scheduling service 144 sends API requests 130 based on the service type 128.

After configuring APIs 122 within configuration tool 120, monitoring service 146 executes API request 130 and validates the results against API success criteria 134. Monitoring service 146 executes an API request 130 for APIs 122 configured in API configuration tool 120. Depending on the service type 128 selected in configuration tool 120 for particular APIs 122, backend 140 may use monitor REST service 147, monitor SOAP service 148, and/or monitor MQ service 149, according to some embodiments. Backend 140 uses any monitoring service 146 compatible with service type 128 known to a person of ordinary skill in the art used to monitor APIs.

At 506, API manager UI 110 retrieves API status 172 from backend 140. Monitoring service 146 transmits activity data of APIs 122 to activity log service 150. Activity log service 150 stores an activity log including the activity data of APIs 122 in API status database 145. The activity data may include the status of APIs 122. Backend 140 also uses statistics service 154 to retrieve statistical data for various platforms, applications, and APIs 122 managed by API manager UI 110. Activity log service 150 may also retrieve statistical data from statistics service 154 and store the statistical data within API status database 145.

Backend 140 also uses reporting service 156 to provide reporting data regarding APIs 122. Reporting service 156 retrieves activity data from the activity log stored in API status database 145. Reporting service 156 stores reporting data regarding API 122 within reporting database 155. API manager UI 110 causes a display of the reporting data retrieved from reporting database 155 in API availability report 157. The reporting data may include, but is not limited to, availability data of APIs 122. Backend 140 uses common utilities 158 to alert other teams. Common utilities 158 sends incident notifications regarding unavailable APIs 122.

API manager UI 110 retrieves the activity log data, which includes API status 172, from API status database 145. API manager UI 110 also retrieves API availability report 157 from reporting database 155. API manager UI 110 causes a display of the API availability report 157 to the user.

At 508, API manager UI 110 receives a test script representing the user journey within an application. A user initializes a user journey by creating a user journey test script 163, which represents a test script corresponding to a user journey and the sequence of the particular APIs 122 accessed in the user journey. In some embodiments, user journey test script 163 specifies a sequence of parent application programming interfaces (APIs) called as a user journeys through an application.

At 510, API manager UI 110 generates API dependency map 162 in API dependency tool 160. After monitoring service 146 executes API request 130 and validates the results against API success criteria 134, the user builds an API dependency map 162 to connect particular APIs 122 to service a user journey. API dependency map 162 causes a display of all API dependencies in one comprehensive visual representation. API manager UI 110 includes API dependency tool 160, which enables the creation of one or more API dependency maps 162 (API dependency map 162-A, API dependency map 162-B, , API dependency map 162-X).

API dependency map 162 may be a visual representation of user journey test script 163 and the parent APIs 164 and API dependencies 165 flowing therefrom within a user journey. API dependency map 162 is a visual representation of user journey test script 163 and parent APIs 164 and API dependencies 165 flowing therefrom within a user journey. API dependency map 162 includes a sequential map of visual objects. The sequential map illustrates (1) each of the parent APIs 164 specified in the user journey test script 163 and (2) for each of the parent APIs 164, any dependent API 165 called by the respective parent API 164.

A user builds an API dependency map 162 by connecting objects representing parent APIs 164 (parent API 164-A, parent API 164-B, , parent API 164-X) and API dependencies 165 (API dependency 165-A, API dependency 165-B, . . . , API dependency 165-X) involved in servicing a user journey. Parent APIs 164 represent the initial APIs 122 called when servicing a user journey. API dependencies 165 represent APIs 122 called downstream from parent APIs 164 when servicing a user journey. For example, in API dependency map 162-A, the first parent API 164 may call API dependency 165-B, which may then in turn call API dependency 165-C. Parent APIs 164 and/or API dependencies 165 may continue to call API dependencies downstream until the test script has executed through the entire user journey.

As a result, API dependency map 162 may visually display a map of a sequence of objects representing parent APIs 164 and/or API dependencies 165 flowing from the object representing user journey test script 163.

At 512, API manager UI 110 executes user journey test script 163. API manager UI 110 transmits notifications to entities managing unavailable APIs 122. After the user builds a complete API dependency map 162, API manager UI 110 may receive a request from the user to execute user journey test script 163 to validate the user journey. As a result of executing the user journey test script 163, the API 122s call dependent APIs 122 downstream until each API 122 has sequentially called parent APIs 122 and dependent APIs 122 in the user journey.

At 514, API manager UI 110 causes a display of available and unavailable parent APIs 164 and/or API dependencies 165 in API dependency map 162. If certain APIs 122 and dependent APIs therefrom are unavailable, dependency map 162 visually indicates which APIs 122 are unavailable. For example, the object of a parent API 164 and/or API dependency 165 representing an unavailable API 122 may be outlined as red. This distinguishes the unavailable APIs from other available APIs within the dependency map 162, which enables the user to quickly identify which APIs 122 in the user journey are experience outage.

At 516, API manager UI 110 retrieves a request to view the API status 172 for parent APIs 164 and/or API dependencies 165 corresponding to particular APIs 122 in API dependency map 162. A user selects from API manager UI 110 an object representing a particular parent API 164 and/or API dependency 165 in API dependency map 162. API manager UI 110 retrieves this request to view the API status 172 for a parent API 164 and/or API dependency 165 corresponding to a particular API 122.

API manager UI 110 transmits a request to dependency service 152 to provide the API status 172 of the each of the APIs 122 represented by the parent APIs 164 and/or API dependencies 165 in API dependency map 162. Dependency service 152 enables the creation and management of dependency trees containing APIs 122. Dependency service 152 may provides status of each of the APIs 122 within a user journey in a dependency map 162. Dependency service 152 may use the activity data from the activity log stored in API status database 145 to provide the API status 172 of APIs 122 in a dependency map 162. Dependency service 152 transmits the API status 172 of APIs 122 in API dependency map 162 to API manager UI 110.

API manager UI 110 retrieves API status 172 from dependency service 152 to generate the status of APIs 122 corresponding to parent APIs 164 and/or API dependencies 165 in status view 170. API manager UI 110 causes a display of status view 170 corresponding to the API 122 represented by the object representing parent API 164 and/or API dependency 165 selected by the user. Status view 170 provides the API status 172 of parent APIs 164 and/or API dependencies 165. API status 172 includes, but is not limited to, the endpoint name 124, API request 130, endpoint URL 126 corresponding to APIs 122 within API dependency map 162, and/or API response 174, which is the returned API response corresponding to the API request 130 of APIs 122 within API dependency map 162.

At 518, API manager UI 110 may transmit a request to provide a notification of unavailable APIs 122. Backend 140 uses common utilities 158 to alert other teams. Common utilities 158 sends incident notifications regarding unavailable APIs 122. This results in expediting identification of the unavailable API 122 and reduction of the API outage duration.

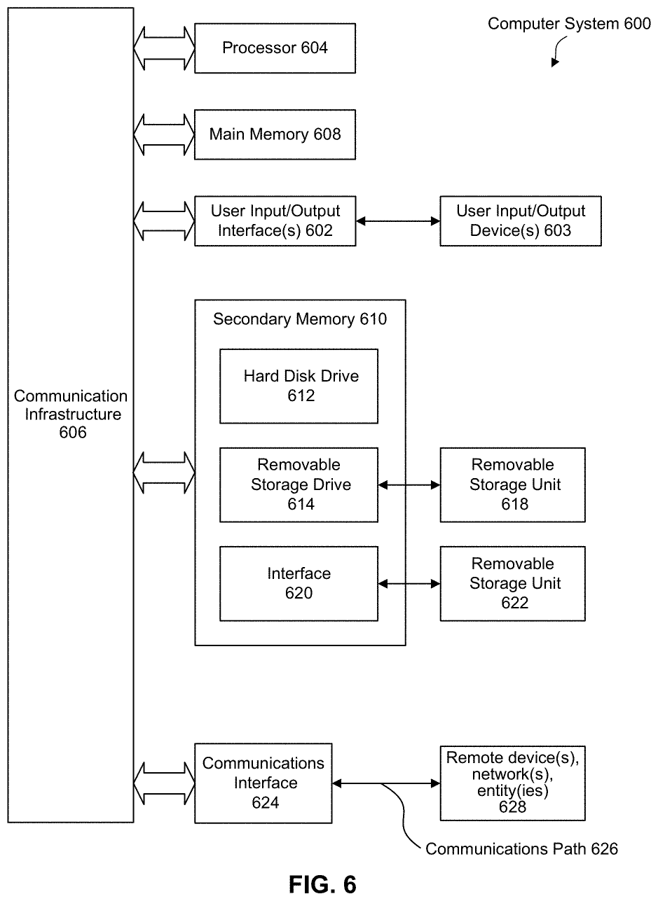

Various embodiments can be implemented, for example, using one or more computer systems, such as computer system 600 shown in FIG. 6. FIG. 6 is described with reference to FIGS. 1-5. Computer system 600 can be used, for example, to implement method 500 of FIG. 5. For example, computer system 600 can implement and execute a set of instructions comprising configure APIs 122, monitor and schedule APIs 122, build an API dependency map 162, execute a test script representing API dependency map 162, and/or retrieve API status 172 of parent APIs 164 and/or API dependencies 165. Computer system 600 can be any computer capable of performing the functions described herein.

Computer system 600 can be any well-known computer capable of performing the functions described herein.

Computer system 600 includes one or more processors (also called central processing units, or CPUs), such as a processor 604. Processor 604 is connected to a communication infrastructure or bus 606.

One or more processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for analyzing a test of a user journey, comprising:
receiving, at a graphical user interface (GUI), a test script representing a user journey within an application, wherein the test script specifies a sequence of application programming interfaces (APIs) that have been called as a user journeys through the application;
generating an API dependency map within the GUI, wherein the API dependency map comprises a sequential map of visual objects, the sequential map of visual objects illustrating (1) each of the APIs specified in the test script and (2) any dependent API called by each of the APIs;
executing the test script representing the user journey;
generating, for presentation within the GUI, a status corresponding to each of the APIs and the dependent APIs called when executing the test script, wherein the status of APIs correspond to respective visual objects selected by the user; and
receiving, from a user, a selection of the respective visual objects corresponding to one of the APIs or dependent APIs called when executing the test script;
causing display of the generated status of the selected API or dependent API within the GUI,
wherein at least one of the receiving, generating, executing, and causing are performed by one or more computers.

2. The method of claim 1, further comprising:
generating, for presentation within the GUI, the status of APIs called when executing the test script, wherein the status comprises an endpoint URL of the API and an API request,
wherein at least one of the generating is performed by the one or more computers.

3. The method of claim 1, further comprising:
retrieving a response to an API request for the APIs that have been called in the user journey within the application; and
generating, for presentation within the GUI, the status of APIs called when executing the test script, wherein the status comprises the response to the API request,
wherein at least one of the retrieving and generating is performed by the one or more computers.

4. The method of claim 1, further comprising:
retrieving data representing the status of the APIs; and
causing a display of the API dependency map visually indicating, by the visual objects, which of the APIs called in the user journey are available or unavailable based on the data representing the status of the APIs,
wherein at least one of the retrieving and causing are performed by the one or more computers.

5. The method of claim 1, further comprising:
retrieving a request to add or remove one or more of the visual objects from the API dependency map,
wherein at least one of the retrieving is performed by the one or more computers.

6. The method of claim 1, further comprising:
retrieving data representing the status of the APIs;
transmitting a request to provide a notification of unavailable APIs corresponding to one of the visual objects in the API dependency map based on the data representing the status of the APIs,
wherein at least one of the retrieving and transmitting are performed by the one or more computers.

7. The method of claim 1, further comprising:
retrieving requests to register the APIs, wherein the request comprises an endpoint URL of the API, a service type of the API, and an API request,
wherein at least one of the retrieving is performed by the one or more computers.

8. A system, comprising:
a memory; and
at least one processor coupled to the memory and configured to:
receive, at a graphical user interface (GUI), a test script representing a user journey within an application, wherein the test script specifies a sequence of application programming interfaces (APIs) that have been called as a user journeys through the application;
generate an API dependency map within the GUI, wherein the API dependency map comprises a sequential map of visual objects, the sequential map of visual objects illustrating (1) each of the APIs specified in the test script and (2) any dependent API called by each of the APIs;
execute the test script representing the user journey;
generate for presentation within the GUI a status corresponding to each of the APIs and the dependent APIs called when executing the test script, wherein the status of APIs presented correspond to respective visual objects selected by the user;
receive, from a user, a selection of the respective visual objects corresponding to one of the APIs or dependent APIs called when executing the test script; and
cause display of the generated status of the selected API or dependent API within the GUI.

9. The system of claim 8, wherein the at least one processor is configured to:
generate for presentation within the GUI the status of APIs called when executing the test script, wherein the status comprises an endpoint URL of the API and an API request.

10. The system of claim 8, wherein the at least one processor is configured to:
retrieve a response to an API request for the APIs that have been called in the user journey within the application; and
generate for presentation within the GUI the status of APIs called when executing the test script, wherein the status comprises the response to the API request.

11. The system of claim 8, wherein the at least one processor is configured to:
retrieve data representing the status of the APIs; and
causing a display of the API dependency map visually indicating, by the visual objects, which of the APIs called in the user journey are available or unavailable based on the data representing the status of the APIs.

12. The system of claim 8, wherein the at least one processor is configured to:
retrieve a request to add or remove one or more of the visual objects from the API dependency map.

13. The system of claim 8, wherein the at least one processor is configured to:
retrieve data representing the status of the APIs; and
transmit a request to provide a notification of unavailable APIs corresponding to one of the visual objects in the API dependency map based on the data representing the status of the APIs.

14. The system of claim 8, wherein the at least one processor is configured to:
retrieve requests to register the APIs, wherein the request comprises an endpoint URL of the API, a service type of the API, and an API request.

15. A non-transitory computer-readable medium having instructions stored thereon that, when executed by at least one computing device, cause the at least one computing device to perform operations comprising:
receiving, at a graphical user interface (GUI), a test script representing a user journey within an application, wherein the test script specifies a sequence of application programming interfaces (APIs) that have been called as a user journeys through the application;
generating an API dependency map within the GUI, wherein the API dependency map comprises a sequential map of visual objects, the sequential map of visual objects illustrating (1) each of the APIs specified in the test script and (2) any dependent API called by each of the APIs;
executing the test script representing the user journey;
generating for presentation within the GUI a status corresponding to each of the APIs and the dependent APIs called when executing the test script, wherein the status of APIs presented correspond to respective visual objects selected by the user;
receiving, from a user, a selection of the respective visual objects corresponding to one of the APIs or dependent APIs called when executing the test script; and
causing display of the generated status of the selected API or dependent API within the GUI.

16. The non-transitory computer-readable medium of claim 15, the operations further comprising:
generating for presentation within the GUI the status of APIs called when executing the test script, wherein the status comprises an endpoint URL of the API and an API request.

17. The non-transitory computer-readable medium of claim 15, the operations further comprising:
retrieving a response to an API request for the APIs that have been called in the user journey within the application; and
generating for presentation within the GUI the status of APIs called when executing the test script, wherein the status comprises the response to the API request.

18. The non-transitory computer-readable medium of claim 15, the operations further comprising:
retrieving data representing the status of the APIs; and
causing a display of the API dependency map visually indicating which one of the visual objects representing the APIs and the dependent APIs are available or unavailable based on the data representing the status of the APIs.

19. The non-transitory computer-readable medium of claim 15, the operations further comprising:
retrieving a request to add or remove one or more of the visual objects from the API dependency map.

20. The non-transitory computer-readable medium of claim 15, the operations further comprising:
retrieving requests to register the APIs, wherein the request comprises an endpoint URL of the API, a service type of the API, and an API request.
